(19) United States
(12) Patent Application Publication
(10) Pub. No.: US 2015/0007344 A1
(43) Pub. Date: Jan. 1, 2015

(54) DISPLAYING COLLECTIONS OF DIGITAL CONTENT ITEMS

(71) Applicant: Kobo Inc., Toronto (CA)

(72) Inventors: James Wu, Newmarket (CA); Tai Toh, Toronto (CA); Anthony O'Donoghue, Toronto (CA)

(21) Appl. No.: 13/930,629

(22) Filed: Jun. 28, 2013

(51) Int. Cl. G06F 21/10

(52) U.S. Cl. CPC G06F 21/10
USPC 726/27

(57) ABSTRACT

One or more processors at least partially implement a transfer of the right of possession of a digital content item by deleting or disabling the one or more files corresponding to the content portion of the particular digital content item. The one or more processors delete or disable the one or more files corresponding to the content portion, without deleting or disabling the one or more files corresponding to the metadata for visually representing the particular digital content item. The one or more processors further provide an interface that accesses the data store in order to display the visual representation of each digital content item in the collection, including the visual representation of the particular digital content for which the right of possession has been transferred.

### TECHNICAL FIELD

Examples described herein relate to a computing device, system and method for displaying a collection of digital content items.

### BACKGROUND

Digital content has become pervasive, in that consumers can now purchase various types of digital content items from numerous network or online sources. The distribution of digital content often includes programmatic controls to preclude users from distributing the content themselves.

### BRIEF DESCRIPTION OF THE DRAWINGS

FIG. 1 illustrates a system in which a computing device can display e-books previously acquired by the user, while enabling the user to selectively transfer a right of possession to individual e-books, according to one or more embodiments.

FIG. 2 illustrates an example of a computing device in accordance with examples described herein.

FIG. 3 illustrates an example device system to provide an interface to display e-books of a collection, including e-books that the user previously acquired and then transferred, according to one or more embodiments.

FIG. 4 illustrates an example method for operating a computing device to transfer a right of possession to an e-book, while including an interface that displays a collection of a user's e-books, including those e-books which the user previously transferred, according to an embodiment.

FIG. 5 illustrates an example method for operating a network service to provide for transfers to the right of possession of e-books while enabling visual representations of the transferred e-books to be viewed, according to an embodiment.

FIG. 6 illustrates an example interface for enabling a user to view a collection of e-books, including those en-books that the user previously transferred.

### DETAILED DESCRIPTION

Examples described herein enable computing devices to download or otherwise acquire digital content items, and further to transfer acquired digital content items in a manner that programmatically precludes a user from accessing a content portion of the acquired digital content item. While the user is precluded from accessing content portions of transferred digital content items, programmatic components of a user's computing device are able to access and utilize metadata for rendering visual representations of the digital content items. In some examples, a programmatic component can display visual representations of digital content items that the user has acquired, including those digital content items for which the user is precluded from consuming as a result of having previously transferred that content item.

Accordingly, some embodiments include a computing device having programmatic components that render visual representations of digital content items acquired by the user, including digital content items that the user acquired and then transferred.

According to some embodiments, a computing device includes a set of memory resources and one or more processors. The set of memory resources include instruction memory that stores a set of instructions, and a data store that stores a collection of digital content items. Each of the digital content items includes one or more files corresponding to a content portion and one or more files that include metadata for providing a visual representation of the digital content item. The one or more processors are coupled to the memory to retrieve instructions. In response to a request from the user to transfer the right of possession of a particular digital content item to a second user, the one or more processors at least partially implement the transfer of the right of possession of the digital content item by deleting or disabling the one or more files corresponding to the content portion of the particular digital content item. In particular, the one or more processors delete or disable the one or more files corresponding to the content portion, without deleting or disabling the one or more files corresponding to the metadata for visually representing the particular digital content item. The one or more processors further provide an interface that accesses the data store in order to display the visual representation of each digital content item in the collection, including the visual representation of the particular digital content for which the right of possession has been transferred.

Still further, some examples provide a system or service to control distribution of digital content items. A collection of digital content items is associated with an account, where at least some of the digital content items of the collection are downloaded on a computing device that is associated with the account. The digital content items include one or more files corresponding to a content portion and one or more files that include metadata for providing a visual representation of the individual digital content items. A request is received from a user to transfer a right of possession to one of the digital content items of the collection that is downloaded on the associated computing device. In response to receiving the request, the computing device that is associated with the account is programmatically instructed to delete or disable the one or more files corresponding to the content portion of the particular digital content item, without deleting or disabling the one or more files that include metadata for providing the visual representation of the particular digital content item. The computing device is signaled to include indicia that indicates the right of possession to the particular content item has been transferred.

With respect to examples described herein, digital content items can include, for example, media files for songs, television shows, movies, e-books, and digital comic books. While numerous embodiments described herein make reference to e-books, it should be appreciated that e-books are just one example of a digital content item for use with examples as described, and embodiments described herein are applicable to digital content items other than e-books, such as songs (or albums), videos (e.g., movies, television shows, video clips, music videos, etc.), or other works that can be embodied in a digital medium and subject to copyright laws.

“E-books” are a form of an electronic publication that can be viewed on computing devices with suitable functionality. Multi-function devices, such as cellular-telephony or messaging devices, can utilize specialized applications (E.g., e-reader apps) to view e-books. Still further, some devices (sometimes labeled as “e-readers”) can be centric towards content viewing, and e-book viewing in particular.

As used herein, a transfer in the right of possession is intended to mean that the right of a given user to enjoy or otherwise consume a content portion of a digital content item is transferable. A transfer in the right of ownership to a particular digital content item can constitute a transfer in the right of possession. However, many examples described herein recognize that consumers do not often purchase true ownership to individual content items, as various digital rights management rules and laws preclude the user from truly owning a purchased copy of a digital content item. For simplicity, some examples may be described in the context of purchasing a digital content item (such as an e-book), and such example should be read in context in which what is actually purchased is a right of possession that permits the user to enjoy or otherwise consume (e.g. read, playback, etc.) a digital content item. When reference is made to a “transferred” digital content item, it is intended to mean that a right to possession of at least a content portion of the digital content item has been transferred. Terms such as “resell” are intended as an example for the transfer in the right of possession to at least the content portion of a digital content item.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

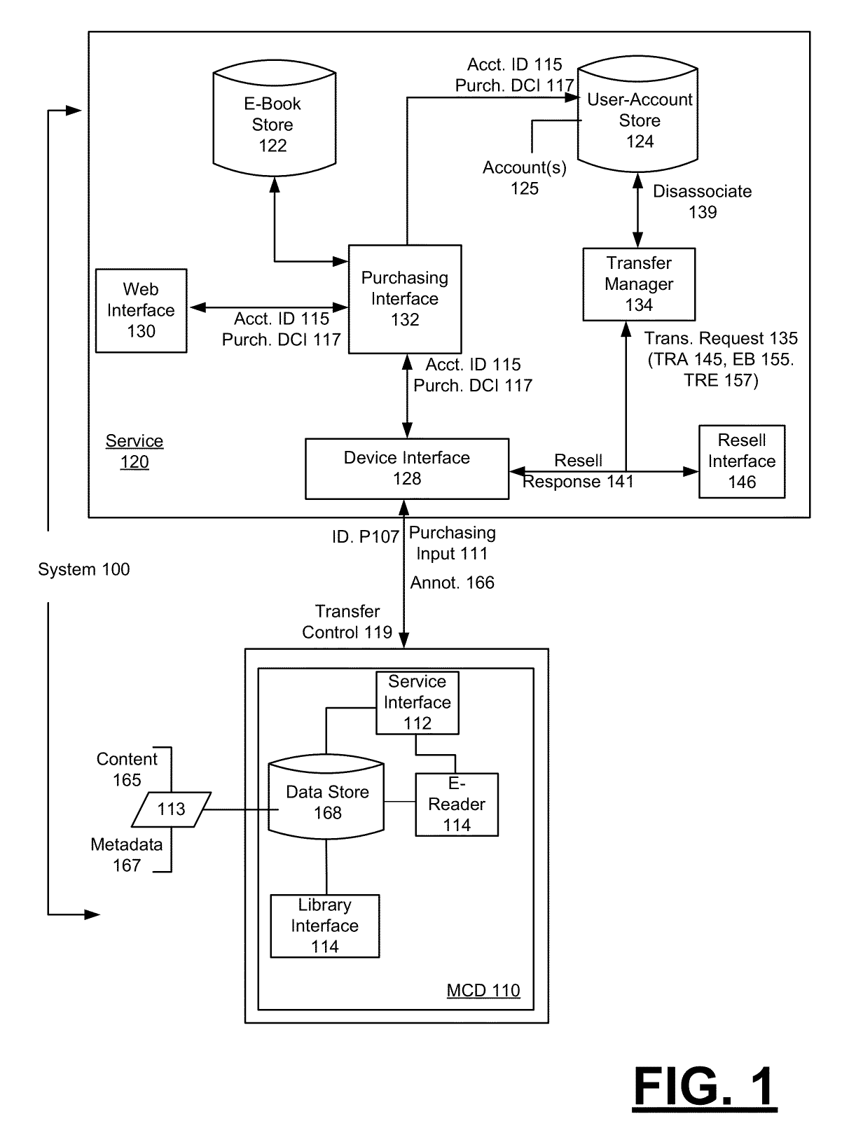

FIG. 1 illustrates a system in which a computing device can display e-books previously acquired by the user, while enabling the user to selectively transfer a right of possession to individual e-books, according to one or more embodiments. In an example of FIG. 1, system 100 includes a mobile computing device 200 and a network service 120. The network service 120 can include multiple servers and other computing resources that provide various e-book services, including services in which e-books are sold, re-sold, borrowed, shared, downloaded and/or stored. The mobile computing device 200 can correspond to any computing device on which an e-book can be rendered and consumed. For example, the mobile computing device 200 can correspond to a tablet, telephony/messaging device (e.g., smart phone) or portable computing device. The mobile computing device 200 can run an e-reader application 114 that links the device to the service 120 and enables e-books provided through the service to be viewed and consumed.

In some implementations, the mobile computing device 200 is equipped with hardware and software to optimize reading electronic content, including e-books. For example, the mobile computing device 200 can have a tablet like form factor, although variations are possible. In some cases, the mobile computing device 200 can also have an E-ink display.

The network service 120 can include a device interface 128, which communicates with individual devices that access the service. Among other resources, the network service 120 can include a network e-book store 122 and a user account store 124. The user account store 124 can associate computing device 200 with a user and an account 125. The account 125 can also be associated with one or more e-books, which can be stored in the network e-book store 122. As described further, the user account store 124 can retain metadata for individual accounts 125 to identify e-books that have been purchased or made available for consumption for a given account. As described with many examples, the metadata can include supplemental transaction information, such as whether the user has purchased or otherwise acquired the right to re-transfer an e-book.

The mobile computing device 200 may be associated with the user account 125, and multiple devices may be associated with the same account. As described in greater detail below, the mobile computing device 200 can store e-books that are purchased or otherwise made available to the user of the mobile computing device 200. The mobile computing device 200 can also locally store other metadata and account information, such as metadata that identifies which e-books the user has the right to re-transfer (e.g., re-sell e-book).

In some embodiments, the network service 120 communicates with an application or other functionality provided on the mobile computing device 200 in order to enable a user conduct purchasing activity for digital content items made available from or through the service 120. Specific examples of purchasing activity that can be enabled for mobile computing device 200 include the ability to purchase or otherwise download digital content item, such as e-books, as well as the ability to re-sell or transfer rights to such digital content items to other users. Still further, other types of activities that can be enabled for mobile computing device 200 include an ability to share an experience with the digital content item with other like-minded users.

According to some embodiments, network service 120 can include the web interface 130, a purchasing interface 132, and a transfer manager 134. The purchasing interface 132 can provide functionality to enable users to access and utilize the network e-book store 122. The purchasing interface 132 can be provided as, for example, an online store which interfaces or otherwise uses the network e-book store 122. The purchasing interface 132 enables a user to perform various kinds of purchasing activity, including activity to search for e-books, read reviews, make purchases for e-books, and purchase or otherwise acquire right to re-sell purchased e-book. For example, the user can purchase an e-book by making payment and then downloading a digital copy of the e-book to a device associated with the user's account. The purchasing interface 132 can include functionality for linking a user account so as to enable payment, as well as to link a purchase or otherwise downloaded digital content item with the user's account 125. In some examples, multiple devices may be associated with the user's account 125, and the purchased digital content item can be downloaded and/or made available to each device that is associated with the particular user account.

In implementation, mobile computing device 200 can be operated to communicate with device interface 128 to access the purchasing interface 132. For example, the user can operate the mobile computing device 200 to access the online bookstore for an e-reader, or alternatively, for a tablet on which an e-reader application is provided. In one implementation, the user can operate an application on the mobile computing device 200 which specifies an identifier 107 that can be used to determine a user's account. For example, the application running on the mobile computing device 200 can be associated with a login that is shared by the user's account, or alternatively the network service 120 can use an identifier 107 transmitted by the mobile computing device 200 to link to the user's account (e.g., link to account identifier 115).

In variations, the user can access the purchasing interface 132 through the web interface 130. For example, the user can access a website corresponding to network service 120, and then make a purchase of a particular digital content item using account identifier 115. Thus, according to various implementations, a user can perform different kinds of purchasing activity through, for example, either the mobile computing device 200 (e.g., application on the mobile computing device) or web browser (to access website).

In one example, a purchasing input 111 can be generated from the mobile computing device 200 in response to use input. On the network service 120, the purchasing input 111 can be communicated via the device interface 128 to the purchasing interface 132. The purchasing input 111 can be directed towards a purchasing activity, such as a search for an e-book, a request to purchase an e-book, a request to re-sell an e-book, and/or an input to purchase an option to re-sell an e-book. Alternatively, the purchasing input 111 can originate from a user accessing a corresponding website and using a web browser, and communicated to the network service 120 using a web interface 130 (e.g., web page). The purchasing input 111 can be linked to the account identifier 115 of the user, which can be associated with user information stored in the user account store 124. The user information can include transaction information such as the user's credit card account etc.

According to examples described herein, a user can access the network service 120 to (i) purchase an e-book (or other form of digital content item), and (ii) transfer right of possession to an e-book. The purchasing of the e-book can correspond to the user acquiring a right of possession to read the e-book. In one example, the purchasing input 111 can specify (or be correlated to) the account identifier 115 and a purchased e-book 117 (e.g., specific e-book that is being purchased).

The purchasing interface 132 can record the user's purchasing activity in connection with, for example, a purchased e-book 117. Thus, for example, when the user elects to purchase an e-book 117, the transaction can be recorded in the user account store 124 using the account identifier 115 and an identifier for the purchased e-book 117.

In one embodiment, a user can make a request 135 to re-sell a previously purchased e-book 155. For example, the user may make the request through the application 114 running on the mobile computing device 200. A transfer manager 134 can implement processes to enable or facilitate the transfer, including handling digital rights management issues relating to the e-book that is being requested for transfer. For example, with reference to FIG. 1, many e-books provided through the network service 120 are provided with a right of possession that is specific to a user or an account. In many cases, the right of possession allows the user to obtain copies on one or more devices that are linked to the user's account. Typically, however, the right of possession conveyed from the network service 120 prohibits or limits the ability of the user to copy or duplicate the e-book on other computing devices that are not linked to the user's account.

In response to a transfer request 135, a response 141 may be communicated by the transfer manager 134 via the device interface 128 (or alternatively, to the user via the web interface 130). The response 141 may correspond to an approval or denial of the transfer request 135. For example, if the request is approved, a transaction record 147 can be generated for the particular e-book, based on user input, and the user can communicate the transaction record 147 to other individuals. In one implementation, the user may be provided access to re-sell interface 146 for a particular e-book. If the user is able to re-transfer the e-book, the user may be enabled to communicate a transaction record 147 to the re-sell interface 146. The re-sell interface 146 can correspond to an online environment where used e-book transactions can take place. Alternatively, the transaction record 147 can be communicated through other communication mediums, such as to a specific user by way of electronic communication (e.g., e-mail, post the thread etc.).

The transfer manager 134 can include processes for implementing the transfer of rights to a particular e-book from one user to another. The user can, for example, offer the e-book for resale through an online medium such as the re-sell interface 146. As mentioned, the user can generate the transaction record 147, which can be stored with the user account, and/or communicated to persons or groups who may be interested in making the purchase. Still further, the user may simply communicate informally to friends and family regarding the availability of the e-book for transfer.

The transfer manager 134 can receive or monitor for a transfer request 159 from a user who acquired an e-book (i.e., the transferor of the e-book). In implementation, the request 135 can specify the user (or transferor) account 145, and the particular e-book 155 that the user is requesting to transfer. Additionally, the request 135 can specify the account or location of the transferee. In some implementations, the transfer manager 134 references the request 135 to the user-account store 124 in order to determine if the user has the right to transfer the specified e-book (e.g., whether the e-book was purchased by the user, and/or whether the user purchased an option for the e-book). Assuming the user has the right to purchase the e-book, the transfer manager 134 implements operations to transfer the e-book. Alternatively, the request to transfer may originate from a transferee who purchases the e-book, provided that the transferee can show proof of sale. In some implementations, the transfer request can identify the user account 115, the particular e-book 155 that is being transferred, and the account 157 of the user who is acquiring the book. For example, the user acting as the transferor can make the request to transfer the particular e-book by specifying information, such as the identifier of the particular e-book, the transferor's user account 115, and the transferee user account 157. The check as to whether the user has the right to transfer the particular e-book can be made when the transfer request is made, or before when the transfer request is made (e.g., as a separate request). Alternatively, the transferee can make a request by specifying the transferor's user account 115, the transferee user account 157, and the particular e-book that is the subject of the transaction, along with data that indicates proof of purchase.

In some examples, the transfer manager 134 can implement the transfer of rights from the user that is the transferor to the user that is the transferee. Implementation of the transfer request 159 can include disassociating the particular e-book 155 from the transferor user account. The particular e-book can be disassociated 139 or marked so that it is no longer available for download to the user from the network service 120. Additionally, the transfer manager 134 can direct, cause or otherwise confirm that local copies of the e-book 155 that is the subject of the transfer are made unavailable for consumption on the devices associated with the particular account. In some embodiments, the e-books are deleted in whole (e.g., completely removed from memory) or in part (e.g., contents deleted, but metadata such as book cover can be maintained). As an alternative or variation, the network service 120 can disassociate the particular e-books by programmatically directing the mobile computing device 200 to electronically disable (e.g., lock) the local copy (or content portions thereof) of the transferred e-book.

The transfer manager 134 can also perform steps to add or associate the subject e-book to the transferee account 157. For example, the transferee may have an existing account with the user account store 124, and the transfer manager 134 may associate data in the user account store 124 to enable the transferee user to download the e-book from the network e-book store 122 (e.g., through the purchasing interface 132). Alternatively, the transfer manager 134 can implement, or communicate with other processes that implement issuance of a coupon or receipt for redemption of the e-book from an online bookstore.

In implementing the transfer, the transfer manager 134 can also perform steps for distributing funds in connection with the transfer. In one embodiment, the transfer request 159 (or follow on communication) specifies funds that are exchanged between the transferor and the transferee. Depending on implementation, the transfer manager 134 can distribute funds using a variety of formulas or distribution algorithms. For example, a designated portion of the proceeds can be distributed to the publisher and/or operator of the network service 120.

The computing device 200 can include components for communicating with and utilizing services provided by the network service 120. In example of FIG. 1, the computing device 200 includes a service interface 112, an e-reader 114, a data store 168 that stores a collection of locally stored digital content items 113, and a library interface 116. The service interface 112 operates to programmatically locate the network service 120 over one or more networks (e.g., wireless or cellular network and/or Internet). The service interface 112 also operates to communicate and receive communications (e.g., requests, instructions) and data (e.g., e-books) from the network service 120.

The data store 168 can be implemented with memory resources of the computing device. Downloaded e-books, for example, can be communicated from the service interface 112 to the data store 168. At least some of the digital content items 113 include a content portion 165 and a metadata portion 167 for providing a computer-generated visual representation of the digital content item. For example, individual digital content items 113 can include one or more content files and one or more metadata files.

The library interface 116 can interface with the data store to provide a library view of the collection of e-books. In some embodiments, the library interface 116 is generated from the metadata portion 167 of the digital content items 113. The metadata portion 167 can, for example, include imagery (e.g., graphics provided by a publisher of the e-book), information about a creator of the digital content item (e.g., author), reviews, etc.

Further, in some embodiments, the network service 120 (via the transfer manager 134) can signal transfer control 119 to the computing device 200 to delete, lock or disable the content portion 165 of any transferred digital content item 113. According to at least some embodiments, while the network service 120 locks or disables the content portion 165 of a transferred digital content item, it does not disable or delete the metadata portion. Accordingly, the library interface 116 displays visual representations (e.g., graphics and text) of digital content items 113 that have been transferred, so as to be unavailable for viewing or consumption on the computing device 120.

According to some examples, the user can transfer a personalized e-book or digital content item. For example, the user can transfer (e.g., gift) an annotated version of an e-book. In one example, the mobile computing device 200 includes an e-reader application 114 that enables the user to create annotations by interacting with input mechanisms of the mobile computing device 200. For example, the e-reader application 114 can operate to enable the user to receive input by way of the user providing annotation input 105 via a keyboard or touch screen of the mobile computing device. In one implementation, the annotations 166 can be copied and communicated to the network service 120. When the transfer of the annotated e-book occurs, the annotations 166 can be merged or otherwise combined with an online copy of the e-book. In variations, an actual copy of the e-book with annotations is communicated from the mobile computing device to the network service 120. As a result of the transfer, the mobile computing device 200 deletes or disassociates with the e-book with the annotated comments.

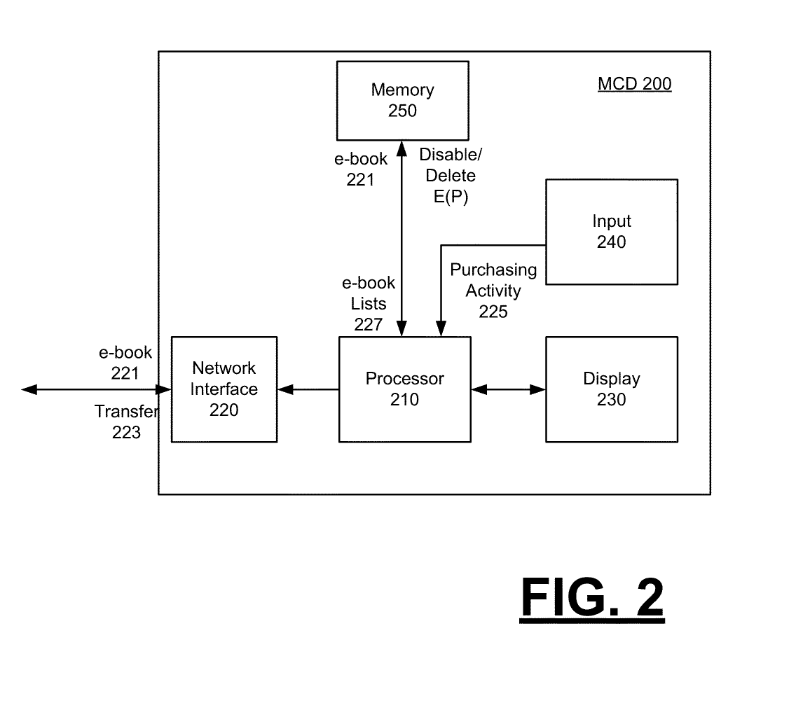

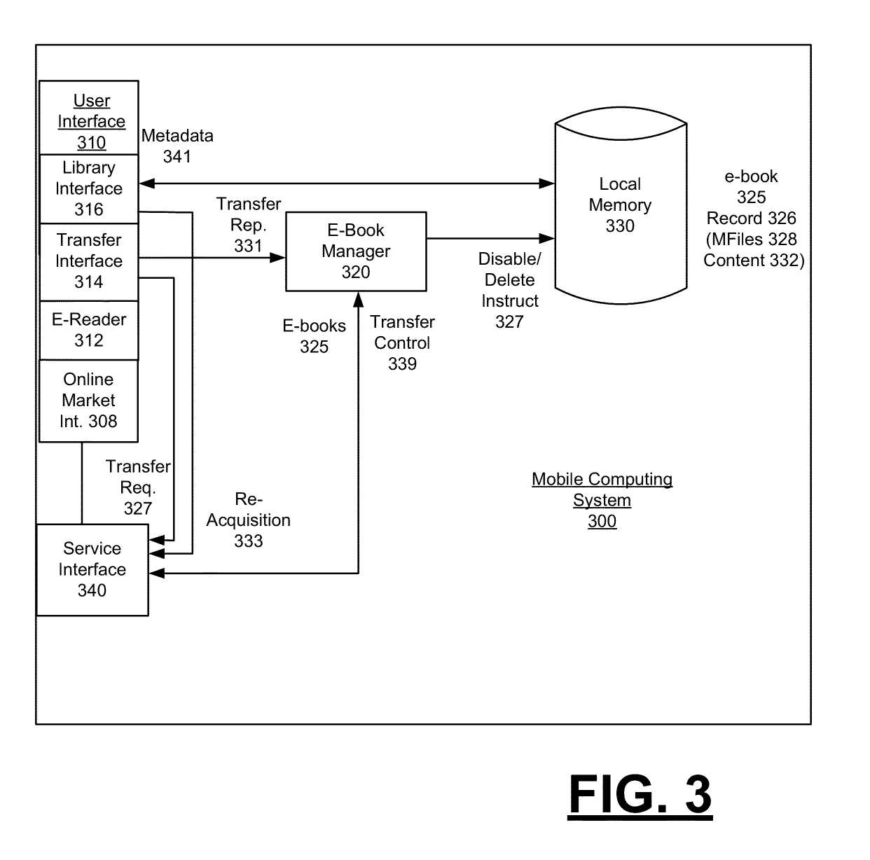

FIG. 2 illustrates an example of a mobile computing device in accordance with examples described herein. The mobile computing device 200 can include a processor 210, a network interface 220, a display 230, one or more input mechanisms 240, and a memory 250. The processor 210 can utilize the network interface 220 to communicate with a network service 120 (see FIG. 1). Accordingly, the computing device 200 provides an example of mobile computing device 200 (as shown with FIG. 1), for use with network service 120. In communicating with the network service 120, the mobile computing device 200 can receive e-books 221 that the user has purchased or otherwise selected to download from the network service. The memory 250 includes instruction memory for storing instructions from which programmatic operations are performed by the processor. Among other functionality, the memory 250 can store instructions that enable the processor 210 to implement programs in accordance with an example of FIG. 1 or FIG. 3. Additionally, the e-books 221 that are downloaded onto the mobile computing device 200 may be stored in the memory 250. The memory 25 can provide a data store that stores records corresponding to individual e-books, including linking content and metadata files that comprise individual e-books.

The processor 210 can execute programs by reading instructions from the memory 250. Additionally, the processor 210 may perform read operations on the memory 250 in order to retrieve stored e-books 221, for rendering on the display 230.

The display 230 can correspond to, for example, a liquid crystal display (LCD) that illuminates in order to provide content generated from processor 210. In alternative variations, for example, the display 230 can be an E-ink display with a white-paper appearance to enhance readability.

In some embodiments, the user may operate the mobile computing device 200 to enter input 219 corresponding to purchasing activities. Such activities can include purchasing e-books 221, re-selling (or offering for resale) purchased e-books, and acquiring options to re-sell purchased e-books. In one implementation, an application on the mobile computing device enables the user to access an online bookstore. The user may have an account established with the online bookstore. The user may operate the mobile computing device 200 to view and/or purchased e-books for consumption on the device 200 (as well as other devices that may be linked to the same account). For example, the user may be able to purchase an e-book by operating an application on the computing device 200. In response to purchasing an e-book, the e-book 221 may automatically be downloaded to the device 200. As described with examples, each downloaded e-book 221 can include a content portion and a metadata portion. When the user downloads the e-book, the user may also acquire the right to read the content portion of the e-book.

In some embodiments, the user can also transfer a purchased or downloaded e-book. Typically, the downloading of the e-book is specific to a user, user device or user account. Once the e-book is transferred, the computing device 200 can receive transfer directives from the network service 120. The transfer directives 223 can cause, for example, any one or more of the following: (i) delete the content portions of the local copy of a specified e-book that was transferred, (ii) disable or programmatically lock the content portions of the contents (e.g., preclude viewing of some or all pages of an e-book) of an e-book that was transferred, or (iii) disable/delete some but not all content (e.g., enable viewing of insert of select pages, first chapter etc.) portions of the transferred e-book.

FIG. 3 illustrates an example device system to provide an interface to display e-books of a collection, including e-books that the user previously acquired and then transferred, according to one or more embodiments. In reference to FIG. 3, a mobile computing system 300 can implement programmatic components for implementing purchasing activities that include purchasing e-books, and implementing transfer of rights to purchased e-books. The mobile computing system 300 can implement some or all of its purchasing activities through communications with an e-book service (such as network service 120, shown in FIG. 1). In some implementations, the mobile computing system 300 can be implemented as an application that runs on a mobile computing device (e.g., such as shown by FIG. 1 or FIG. 2). In a variation, some or all of the functionality described with the mobile computing system 300 can be implemented on or through a network service 120.

In an example of FIG. 3, the mobile computing system 300 includes a user interface 310, an e-book management module 320, a local memory 330, and a service interface 340. The programmatic components shown with the computing system 300 can be provided as part of an application that runs on the computing system 300. For example, the user can download an application onto mobile computing device, to obtain functionality such as described herein, as well as to communicate with a network service 120. Alternatively, the application can be embedded or otherwise preinstalled with other programmatic elements for providing such functionality on a computing device.

The service interface 340 includes application and logic which enables the device to use, for example, a wireless Internet connection, to connect to the network service 120 (see FIG. 1). In connecting with the service, the service interface 340 can transmit data that enables the network service 120 to identify mobile computing system 300 (or alternatively the user) so that the network service 120 can determine the account associated with the mobile computing device. The service interface 340 can be used to retrieve e-books 325 from the network service 120. For example, in identifying the mobile computing system 300 to the network service 120, the network service procures payment information (e.g., stored credit card) that can be used to charge users account when purchasing a new e-book. Each e-book 325 can correspond to a literary work, having pagination and chapter designations. Optional media components, such as images, can also be included in the e-book.

The mobile computing system 300 stores acquired e-books 325 in the local memory 330. In one example, each e-book 325 is associated with a record 326 that links a set of files, including a metadata file 328 and a content file 332. The metadata file(s) 328 can include text information about the content file 332, such as, for example, an author of the e-book, a title, summary and reviews. The metadata 328 can also include imagery for generating, for example, an iconic visual representation of the e-book. The imagery can, for example, be derived from an illustration provided by a publisher (or publishing or creative source) of the particular e-book in the context of marketing the e-book or an alternative medium counterpart (e.g., hardback, paperback etc.).

The metadata 328 can include information that identifies the e-book, including imagery or jacket art (e.g., graphics), information about the author, title, summary, user reviews, etc. In some embodiments, the content 332 corresponds to one or more files that specify pages or chapters of the e-book 325. Likewise, the metadata 328 include files that include the supplementary information, such as the imagery or jacket art.

In identifying the mobile computing system 300, the network service 120 can identify what e-books belong to the account of that device. E-books 325 that are transmitted to the mobile computing system 300 include those that are purchased from the device, or those that the user requested to download. In variations, e-books 325 can automatically be downloaded to the device in response to the occurrence of certain conditions. For example, the user can purchase an e-book on another device, and then subsequently connect to the network service 120 via the mobile computing system 300 to automatically receive their previously purchased e-book. Alternatively, network service 120 can be configured to push e-books to the mobile computing system 300, based on, for example, user account settings, subscription rules, and various other business logic considerations. The e-book management module 320 can manage the storage of downloaded e-books in the local memory of the mobile computing system 300 for subsequent use.

In some embodiments, the user interface 310 includes functionality corresponding to an online market interface 308, an e-reader 312, a transfer interface 314 and a library interface 316. The online market interface 308 may provide a link (e.g., via service interface 340) to network service 120 to enable the user to readily access an online store for e-books. The online market interface 308 can enable the user to purchase e-books, and to effect downloads of purchased e-books to the user device.

The e-reader 312 includes functionality for displaying content of an e-book (e.g., pages). The e-reader 312 can also include other functionality, including enabling interaction such as page or chapter turns, and social media sharing.

The library interface 316 operates to identify individual e-books in the user collection. In one implementation, the library interface 316 lists e-books that were acquired on the particular computing device. In a variation, the library interface 316 lists e-books that were acquired by the account. In the latter case, the devices that are associated with an account can include different portions of the overall user collection (e.g., user may elect to download different e-books on different devices). The library interface 316 operates to provide an agglomerated view of an e-book collection. (e.g., local user collection, account collection, recent purchases etc.). In one implementation, the library interface 316 operates to collect visual representation data 341 for displaying visual representations of individual e-books 325 from local memory 330. In variations, the library interface 316 can receive some or all of the visual representation data 341 from the user's e-book collection from, for example, network service 120. Specifically, the library interface 316 can retrieve visual representation data 341 from the metadata portion 328 of the e-book collection stored in local memory 330. The visual representation data 341 used by the library interface 316 can include imagery (e.g., jacket art) and text (e.g., title, author, brief description) provided by files or other data of the metadata 328 accompanying the record of each e-book 325.

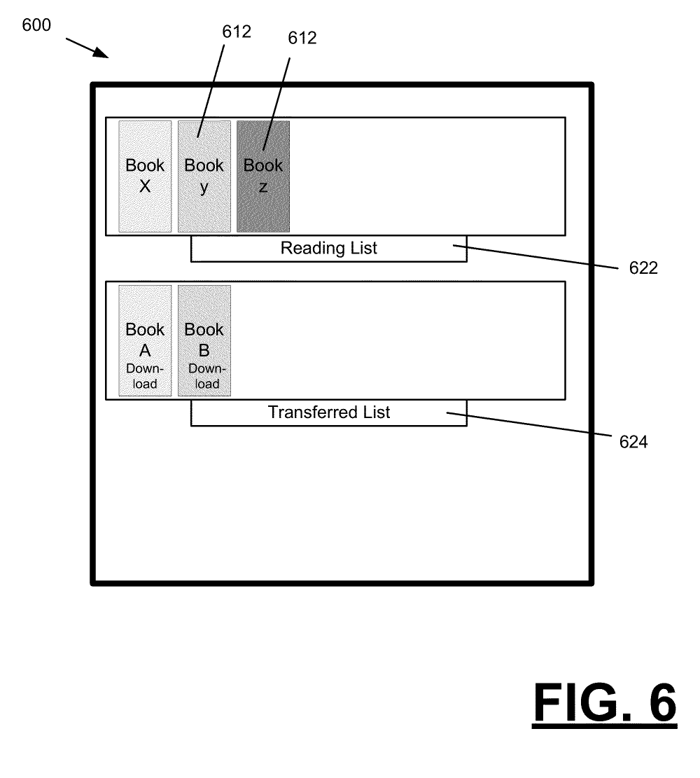

The library interface 316 can enable viewing functionality, such as scrolling or navigation, in order to allow the user to view visual representations of a collection. For example, the visual representations can be displayed by groups or clusters, by category and/or in list form. As described by an example of FIG. 6, one implementation provides for the library interface 316 to display the visual representations using a book shelf paradigm.

The transfer interface 314 to enable the user to enter input that causes the mobile computing system 300 to communicate a request to transfer a given e-book to another account or person. As described with, for example, FIG. 1, a network service 120 can respond to the requests and implement the transfer in the right of possession of the identified e-book.

In one implementation, the transfer interface 314 enables the user to specify the e-book, and to communicate the intent for the user to re-transfer the e-book. Optionally, the user may also operate the transfer interface 314 to specify a price for the e-book, and a medium where the e-book is to be made available. The user can issue a transfer request 327 via the transfer interface 314, to request the network service 120 enable or otherwise provide for the transfer of the specified e-book. The transfer request 327 can be generated with input through the transfer interface 314. The transfer request 327 can identify information such as an identifier of the particular e-book being transferred, as well as the identifier of the transferor (e.g., user's account). Depending on implementation, other information can be specified through the transfer request 327, such as the identity of the transferee (e.g., account of transferee) and conditions of the transfer (e.g., re-sell price, gift, etc.).

The e-book management module 320 manages the storage of e-books 325. When the user issues the transfer request 327, the user may specify the transferee. Depending on implementation, either the network service 120 or the mobile computing system 300 can signal that a transfer is in effect (e.g., transfer made). In one implementation, the network service 120 can signal transfer control 339 to the e-book management module 320. The transfer control 339 can cause the e-book management module 320 to signal 327 delete, disable or otherwise lock the content portions 332 of the particular e-book 325 that was subject to the transfer. For example, the transfer control 339 can cause the e-book management module 320 to lock or delete the content portion (or portions thereof) of the e-book, so that, for example, the jacket or graphic art and other metadata associated with the e-book remains. Moreover, the content portions 332 of specified e-books 325 can be deleted or disabled without deleting or disabling the metadata portions 328 of the same e-books.

As such, the metadata portions 328 of all acquired e-books can be made available to functionality such as provided by the library interface 316. The library interface 316 can, for example, display visual representations of all previously acquired e-books, including those e-books that the user retransferred (e.g., gifted or resold), using the metadata portions 328 of e-books identified in the collection (e.g., stored in local memory 330). At the same time, those e-books that have been retransferred may have some or all of the corresponding content portions 332 deleted or disabled (e.g., locked).

According to embodiments, the transfer control 339 can be communicated to the e-book management module 320 as a programmatic directive generated from, for example, network service 120. In a variation, the transfer control 339 can be communicated to the e-book manager as an internally generated response to a detected user action.

In some variations, the user-interface 310 and/or e-book management module 320 can include or provide additional functionality or indicia to visual representations of e-books that have been transferred. For example, the metadata 328 associated with a transferred e-book can be provided an (i) an indicia indicative of the transferred status of a particular e-book, and (ii) an active link or other selectable feature to the network service 120 for purpose of identifying the transferred e-book and triggering an automatic re-acquisition process (e.g., re-purchase). This allows for the user to reacquire the e-book at a later date.

Methodology

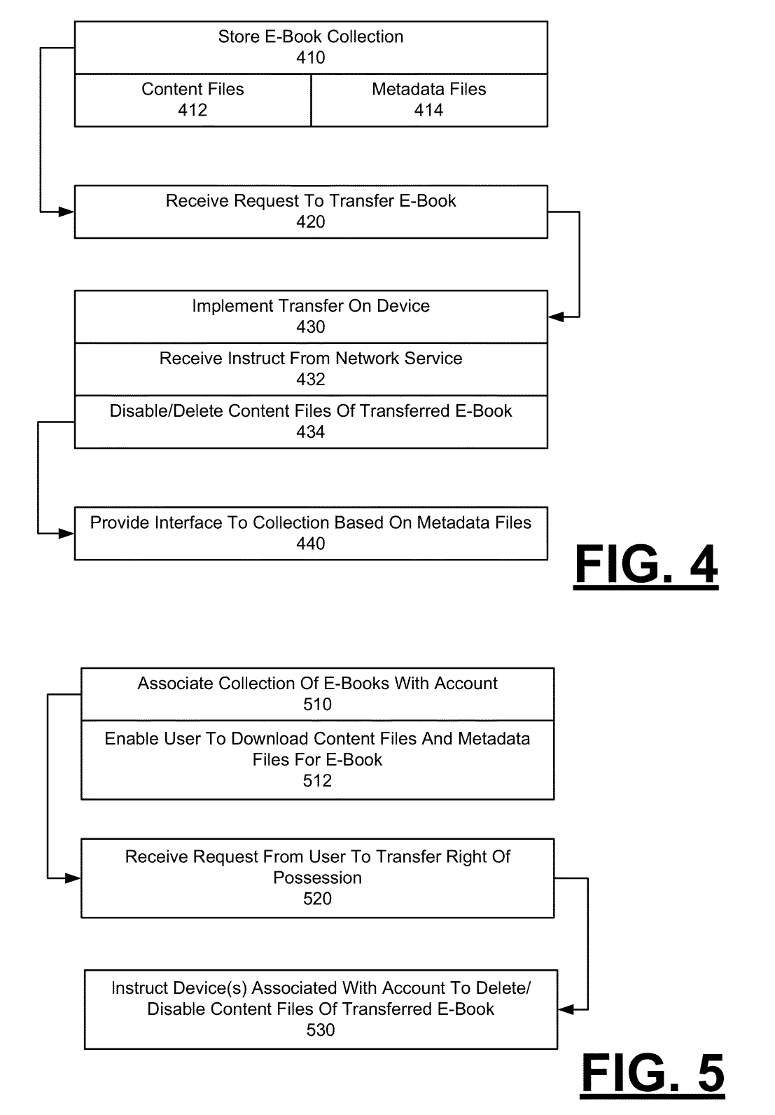

FIG. 4 illustrates an example method for operating a computing device to transfer a right of possession to an e-book, while including an interface that displays a collection of a user's e-books, including those e-books which the user previously transferred, according to an embodiment. FIG. 5 illustrates an example method for operating a network service to provide for transfers to the right of possession of e-books while enabling visual representations of the transferred e-books to be viewed, according to an embodiment. Examples such as described by FIG. 4 or FIG. 5 may be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, an e-book collection for an account is stored on the computing device, or combination of computing devices associated with the account (410). The e-book collection can include multiple e-books, each of which can include a content portion and a metadata portion. In particular, each of the content portion (412) and metadata portion (414) can include one or more files that are stored in association with one another. For example, a given e-book can be associated with a record that links the content files with the metadata files. Accordingly, some implementations provide that the content and metadata portions of the e-books may be stored to exist independently of one another. For example, the content portions can be deleted or disabled without affecting the availability of the metadata portions for use, as described by examples herein.

In some embodiments, a user can elect to transfer the right to possess a given e-book. For example, user can elect a gift or resell an e-book. On a computing device, the user can enter input to initiate our trigger such transfer (420).

Subsequently, the transfer can be implemented on the device or devices associated with the particular account (430). The transfer can be implemented in part using instructions received from the network service that manages the digital rights management to the particular e-book (432). For example, the network service 120 can implement programmatic mechanisms to preclude a user from replicating or otherwise distributing a copy of an e-book to any device other than his own. As an alternative or variation, programmatic mechanisms to manage the digital rights of an e-book can be locally handled on the computing device. For example, the computing device can include software that precludes the operator from communicating a copy of an e-book to another device.

When the transfer is implemented (e.g., the right to possess a given e-book is transferred from one user to another), the computing device is instructed (e.g. from network service 120) to disable or delete the content portions (e.g., content files) of the transfer e-book (434). Such instructions preclude unauthorized duplication of an e-book. As an alternative or variation, the computing device can include functionality that generates instructions to disable or delete the content portions of the transferred e-book.

The collection of stored e-books can be provided an interface to enable the user to view the e-books in their collection (440). For example, library interface 316 can interface with local memory resources 330 in order to provide visual representations of individual e-books that are included in the e-book collection. According to some embodiments, metadata portions of previously acquired but transferred e-books can be maintained and used for purpose of displaying visual representations to that user's collection of e-books. Thus, for example, the library interface 316 can provide visual representations to an e-book that the user has transferred.

With reference to FIG. 5, network service 120 can operate to associate a collection of e-books with the particular user account (510). The user account may include multiple devices. In some implementations, each e-book in a collection can be distributed to one or more of multiple possible devices of the user. The user can download each e-book onto a given device. To download of each e-book can include, for example, one or more content files and one or more metadata files, each of which are linked to a record.

Furthermore, in some implementations, the individual e-books can be distributed to a user under a digital rights management scheme that allows a user to have one digital copy of the acquired e-book per device associated with the user account. Other digital rights management schemes can also be utilized. In one embodiment, the digital rights management scheme enables the user to transfer the right of possession to a particular e-book to another user. As a result of the transfer, the digital rights management scheme precludes the user from consuming or otherwise enjoying the e-book on any device associated with the user account. At the same time, the e-book may be consumed on a device linked to the account of the transferee (user who received the e-book).

In one embodiment, the user can operate an authorized device associated with the user's account to transfer an e-book to another user (520). For example, the user can initiate the retransfer of a particular e-book to another user by reselling the e-book in an online market. The network service may operate to implement the transfer. Among the processes performed, the network service 120 can disassociate the particular e-book with the user account.

Additionally, the network service 120 can instruct devices that have a copy of the transferred e-book to disable or delete the content portions of that e-book (530). Moreover, the instructions from the network service 120 can be communicated without affecting the metadata portions of the same e-book. Thus, for example, a given device may carry a record of the transferred e-book, including the visual representations provided by that e-book, but the user would have no access to the content portions of the e-book.

User Interface

FIG. 6 illustrates an example library interface for displaying an e-book collection of the user. An example interface such as shown with FIG. 6 can be provided by, for example, the user interface 310 of the mobile computing system 300 (see FIG. 3), or through the e-reader application 114 of the mobile computing device 200 (see FIG. 1).

In an embodiment, an interface 600 includes a library presentation that shows individual e-books 612 of a user's digital content library. The library presentation 610 can be generated from the visual representations of e-books associated with an account of the user. More specifically, each visual representation can be based on one or more metadata files that are associated with the record of a corresponding e-book that is associated with the user account. In an example of FIG. 6, the visual representations include imagery, representing jacket covers for individual e-books. The metadata files used to provide the visual representation can include e-books that the user transferred, for which the respective content portions are no longer available to the user. Accordingly, the library representation can include e-books that the user can access and read, as well as e-books that the user has transferred and can thus no longer read or access.

In one example, the library presentation 610 can identify groups of e-books. For example, e-books that the user has transferred can be provided as a separate group. Other groups for e-books can be provided by category or other parameters.

In an example of FIG. 6, the library interface 600 can be implemented using a book shelf paradigm, where individual shelves 622, 624 represent groups of e-books (e.g., transferred e-books). In alternative implementations, for example, the library presentation can be provided in the form of a list, or multiple lists (e.g., where each list corresponds to a group).

Additionally, the interface 600 may include a selection feature 614 that enables the user to select an e-book from the collection for purpose of re-acquiring the e-book after the e-book has been transferred (i.e., transfer in the right of possession).

In one example, the user can enter input through the interface 600 to select, via the selection feature 614, a particular e-book for resale. In response to the user making the selection, a check may be automatically made in order to determine whether the user has acquired the option to re-sell the selected e-book. If the option exists, the user may be able to continue to re-sell the e-book. If the option does not exist, the selection feature 614 can indicate an error or impermissible action.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a set of memory resources, including instruction memory that stores a set of instructions, and a data store that stores a collection of digital content items, each digital content item includes one or more files corresponding to a content portion and one or more files that include metadata for providing a visual representation of the digital content item;
one or more processors that are coupled to the memory to retrieve instructions in performing operations that include:
in response to a request from the user to transfer the right of possession of a particular digital content item to a second user, at least partially implement the transfer of the right of possession of the digital content item by deleting or disabling the one or more files corresponding to the content portion of the particular digital content item, without deleting or disabling the one or more files corresponding to the metadata for visually representing the particular digital content item; and
provide an interface that accesses the data store in order to display the visual representation of each digital content item in the collection, including the visual representation of the particular digital content for which the right of possession has been transferred.

2. The computing device of claim 1, wherein the one or more processors at least partially implement the transfer of the right of possession by locking the one or more files corresponding to the content portion of the particular digital content item.

3. The computing device of claim 1, wherein the interface graphically indicates that the right of possession of the particular digital content item has been transferred.

4. The computing device of claim 1, wherein the interface displays the visual representation of each of the plurality of digital content items in sections, including a section that displays the visual representation of digital content items for which the right of possession has been transferred.

5. The computing device of claim 4, wherein each digital content item in the collection corresponds to an e-book, and wherein the plurality of sections includes book shelves.

6. The computing device of claim 1, wherein the one or more processors generate, with the visual representation of the particular digital content item provided with the interface, a selectable feature that enables a user to re-acquire the right of possession for the particular digital content item from a network service.

7. The computing device of claim 1, wherein the one or more processors at least partially implement the transfer of the right of possession in response to receiving a programmatic instruct from a network service that controls the right of possession for the particular digital content item.

8. The computing device of claim 1, wherein the collection of digital content items include one or more e-books, electronic magazines or electronic comic books.

9. The computing device of claim 1, wherein the collection of digital content items include audio and/or video content.

10. A method for controlling distribution of digital content items, the method being implemented by one or more processors and comprising:
associating a collection of digital content items with an account, wherein at least some of the digital content items of the collection are downloaded on a computing device that is associated with the account and include one or more files corresponding to a content portion and one or more files that include metadata for providing a visual representation of the digital content item;
receiving a request from a user to transfer a right of possession to one of the digital content items of the collection that is downloaded on the computing device that is associated with the account;
in response to receiving the request, programmatically instructing the computing device that is associated with the account to delete or disable the one or more files corresponding to the content portion of the particular digital content item, without deleting or disabling the one or more files that include metadata for providing the visual representation of the particular digital content item; and
signaling the computing device to include indicia that indicates the right of possession to the particular digital content item has been transferred.

11. The method of claim 10, wherein programmatically instructing the computing device includes signaling the computing device to lock the one or more files corresponding to the content portion of the particular digital content item.

12. The method of claim 11, further comprising signaling the device to include a feature with the visual representation of the particular digital content item that links to and identifies the particular digital content item with a network service where the right of possession to the digital content item can be re-acquired.

13. The method of claim 10, wherein the collection of digital content items include one or more e-books, electronic magazines or electronic comic books.

14. The method of claim 10, wherein the collection of digital content items include audio and/or video content.

15. A method for controlling distribution of digital content items, the method being implemented by one or more processors and comprising:
storing a collection of digital content items, each digital content item includes one or more files corresponding to a content portion and one or more files that include metadata for providing a visual representation of the digital content item;
implementing, at least in part, a transfer of the right of possession of the digital content item by deleting or disabling the one or more files corresponding to the content portion of the particular digital content item, without deleting or disabling the one or more files corresponding to the metadata for visually representing the particular digital content item; and
providing an interface that accesses the data store in order to display the visual representation of each digital content item in the collection, including the visual representation of the particular digital content for which the right of possession has been transferred.

16. The method of claim 15, wherein implementing the transfer includes locking the one or more files corresponding to the content portion of the particular digital content item.

17. The method of claim 15, wherein providing the interface includes graphically indicating that the right of possession of the particular digital content item has been transferred.

18. The method of claim 15, wherein providing the interface includes display the visual representation of each of the plurality of digital content items in multiple sections, including a section that displays the visual representation of digital content items for which the right of possession has been transferred.

19. The method of claim 18, wherein each digital content item in the collection corresponds to an e-book, and wherein the multiple sections include book shelves.

20. The method of claim 15, further comprising generating, with the visual representation of the particular digital content item provided with the interface, a selectable feature that enables a user to re-acquire the right of possession for the particular digital content item from a network service.
